(19) United States
(12) Patent Application Publication
(10) Pub. No.: US 2007/0262094 A1
(43) Pub. Date: Nov. 15, 2007

(54) Dispenser for viscous media, having a dispenser reservoir, expelling mechanism and dispenser delivery tube

(76) Inventors: Barbara Muller, Langenau (DE); Werner Mannschedel, Langenau (DE); Daniel Schmid, Gossau (CH)

Correspondence Address: KATTEN MUCHIN ROSENMAN LLP, 575 MADISON AVENUE, NEW YORK, NY, 10022-2585, US

(21) Appl. No.: 11/784,175

(22) Filed: Apr. 5, 2007

(30) Foreign Application Priority Data
Apr. 5, 2006 (DE) 10 2006 016 029.0

(51) Int. Cl. B67D 5/42

(52) U.S. Cl. 222/327

(57) ABSTRACT

The invention relates to a dispenser (1) for viscous media (3), having a dispenser reservoir (2), an expelling mechanism and a dispenser delivery tube (5). The dispenser reservoir (2) has a nozzle (4) and the expelling mechanism exerts a pressure on the viscous medium (3) in the dispenser reservoir (2). Under that pressure, the viscous medium (3) is expelled by way of an opening (6) of the nozzle (4) of the dispenser reservoir (2) and through the dispenser delivery tube (5). The dispenser delivery tube (5) is removable from the dispenser reservoir (2) and has a seat (7) for a stop check valve (8), which is arranged between the nozzle (4), having the opening (6), and the dispenser delivery tube (5).

The invention relates to a dispenser having a dispenser reservoir for viscous media, the dispenser reservoir having a nozzle. In addition, the dispenser has an expelling mechanism and a dispenser delivery tube. The expelling mechanism exerts a pressure on the viscous medium in the dispenser reservoir so that the viscous medium is expelled by way of an opening in the nozzle of the dispenser reservoir and through the dispenser delivery tube.

A dispenser of such a kind can also comprise a tube containing—as the viscous medium—adhesive, cleaning agent, food and/or hygiene agent, such as toothpaste or creams. The expelling mechanism in the case of such tubes is brought about by deformation of the tube. After the nozzle opening has been opened the viscous medium either is expelled directly from the nozzle opening or, after a delivery tube has been placed thereon, is expelled from the delivery tube. The behaviour of the viscous medium in the region of the nozzle and the opening depends, on the one hand, on the nature of the viscous medium and, on the other hand, on the material of the tube.

If, for example, the tube is made from plastics material, which has a certain degree of shape memory and/or is resilient, the viscous medium is drawn back into the tube when the pressure applied diminishes, which is associated with the disadvantage that air can also enter the dispenser reservoir and cause changes in the case of both toothpaste and adhesives or food and reduce the length of time for which the contents will keep. If the dispenser reservoir is made from a soft metal, the disadvantage frequently occurs that there is a subsequent flow of viscous medium out of the opening of the nozzle or out of the tip of the dispenser delivery tube fitted downstream thereof. This subsequent flow is especially marked in the case of viscous media when the medium contains compressible gaseous inclusions, which undergo decompression after the expelling process and consequently result in a substantial subsequent flow of the medium.

This has an especially serious effect in the case of tubes of food to be used as provision for personnel in the weightless conditions of space. In that case, both subsequent flow after delivery of a part of the contents of the dispenser reservoir and the drawing of air into the dispenser reservoir are disadvantageous. In the former case, there is a risk that that portion of food which subsequently flows out will form as drops in the weightless conditions of space and, in the latter case, the length of time that the food will keep is reduced as a result of air being drawn in.

However, both effects of subsequent flow and the drawing-in of air are also disadvantageous under the earth's gravity, at least when the dispenser reservoir contents are a relatively expensive medium or when it is desirable for the viscous medium to be usable over a long period of time.

In the case of highly sensitive and/or expensive media, relatively complex expelling mechanisms are also used. For the purpose, the dispenser reservoir comprises a pressure piston within a pressure cylinder, the pressure piston closing off the cylindrical dispenser reservoir at a location remote from the nozzle. The expelling mechanism comprises, for the purpose, a pressure gun, with which the pressure piston of the pressure cylinder of the dispenser reservoir is in operative connection by way of a rod assembly having a pressure plate. On actuation of the pressure gun, this pressure plate displaces the pressure piston of the dispenser reservoir in the pressure cylinder towards the opening of the nozzle, whereupon the viscous medium is forced to exit by way of the delivery tube.

Such complex expelling mechanisms are used when it is important that that portion of a viscous medium to be expelled is exactly metered out and/or when medium is to be supplied to especially narrow delivery tubes having tips with cross-sections of less than 1 millimetre in diameter. Even in the case of those relatively complex expelling mechanisms, subsequent flow of the viscous medium can result in high losses and, especially, in inexact metering-out. This is especially the case when, as already mentioned in the case of the problems with tubes, compressible gases are contained in the viscous medium.

The problem of the invention is to provide a dispenser in which both the subsequent flow of a viscous medium from a dispenser reservoir and/or from a dispenser delivery tube and also the drawing-in of air into a dispenser reservoir are avoided and as a result the disadvantages of the prior art are overcome. The problem of the invention is especially to provide a dispenser, for dentistry, which makes available, in finely metered-out manner, preferably dental cement and/or root canal filling materials from narrow dispenser delivery tubes without subsequent flow and/or a drawing back in.

The problem is solved by the subject-matter of the independent claim. Advantageous developments of the invention arise out of the dependent claims.

In accordance with the invention, a dispenser having a dispenser reservoir for viscous media is provided, which comprises a dispenser reservoir, an expelling mechanism and a dispenser delivery tube. The dispenser reservoir has a nozzle and the expelling mechanism exerts a pressure on the viscous medium in the dispenser reservoir. When subject to the pressure from the expelling mechanism, the viscous medium is expelled by way of an opening in the nozzle of the dispenser reservoir and through the dispenser delivery tube connected to the dispenser reservoir. The dispenser delivery tube has a seat for a stop check valve preferably arranged between the nozzle, having the opening, and the dispenser delivery tube. In order to put in place the stop check valve, the dispenser reservoir and the dispenser delivery tube are preferably so constructed that they are separable. In order to fit the stop check valve, it is necessary merely to remove the dispenser delivery tube from the dispenser reservoir and to re-assemble the dispenser reservoir and the dispenser delivery tube whilst arranging the stop check valve. The dispenser reservoir and dispenser delivery tube are frequently stored separately so that the stop check valve can be fitted without any problem when they are assembled.

Such a dispenser additionally has the advantage that the opening in the nozzle is, as a result of the nozzle having the stop check valve, protected against entry of air and also against outflow of the viscous medium from the opening. As soon as the pressure from the expelling mechanism diminishes, the stop check valve closes the opening in the nozzle of the dispenser reservoir and accordingly seals off the dispenser reservoir. Only as a result of renewed actuation of the impelling mechanism does the stop check valve change from its closed position to an open position and allow a finely metered amount of the viscous medium to be delivered by way of the dispenser delivery tube for as long as the pressure is exerted by the impelling apparatus.

For all the above-mentioned applications, such a stop check valve arranged between the nozzle, having the opening, and the dispenser delivery tube has advantages, which are not listed in detail. In particular, this dispenser having a stop check valve has an advantage in dentistry, where relatively expensive viscous media have to be dispensed in finely metered manner. For the purpose, the stop check valve preferably comprises a holding ring and a movable valve piston. Resilient holding bands between the holding ring and valve piston hold the valve piston in a closed position, in which the opening of the nozzle of the dispenser reservoir is closed, as long as the expelling mechanism is not actuated. The advantage of this stop check valve is that it is simple to manufacture and can be made smaller to any desired extent so that it can be used for a large number of different dispenser reservoirs of a dispenser irrespective of whether the expelling mechanism is manually actuated, as in the case of tubes, or, for fine metering, is actuated by means of a pressure gun. The movable valve piston automatically returns to the closed position as soon as the pressure of the impelling mechanism diminishes.

In a further preferred embodiment of the invention, the valve piston has towards the opening of the nozzle a truncated cone, the conical outer surface of which seals the opening in the unpressurised state. Instead of a conical outer surface, the contour of the valve piston by which the opening in the nozzle is closed can also be a hemispherical or partially spherical shape. The contour of part of a sphere or of a conical outer surface advantageously ensures that the valve piston can match the opening of the nozzle of the dispenser reservoir even in extreme positions. The resilient holding bands ensure that the movable valve piston lies against the rim of the opening of the nozzle with a predeterminable spring force.

The resilient holding bands are, at a first end, preferably arranged on a cylindrical outer surface of the valve piston. For the purpose, the contour of the valve piston changes from a hemispherical or partially spherical or truncated-cone-shaped contour into a cylindrical contour, to which the first end of the resilient holding bands is fixed. The other end or, that is, the second end of the resilient holding bands is attached to the holding ring, which is fixed in a stationary position. The resilient holding bands can be made relatively short by means of their extending radially outwards from the cylindrical outer surface to the holding ring.

Another possibility is to attach the resilient holding bands so that the resilient holding bands extend tangentially, or at an obtuse angle to the radial, outwards from the cylindrical outer surface towards the holding ring. As the obtuse angle lessens until it becomes a tangent, so the resilient holding bands become more yielding and less rigid.

In order to fix the holding ring in a stationary position, the holding ring is, for example, arranged between the nozzle and the dispenser delivery tube, the dispenser delivery tube preferably having a clamping seat for the purpose.

Alternatively, holding ring and dispenser reservoir have means for fixing the holding ring at the dispenser reservoir, e.g. a screw thread, a Luer-lock closure, a bayonet closure or a clamping closure. This has the advantage that a dispenser delivery tube can be exchanged without exposing the content of the dispenser reservoir to the ambiance, e.g. air.

In a preferred embodiment of the invention, the stop check valve is a one-piece moulded plastics part comprising the valve piston, the holding bands and the holding ring. This arrangement ensures that the stop check valve can be produced cheaply and in large numbers. It is furthermore associated with the advantage that this stop check valve can also be retro-fitted in a large number of applications working with viscous media in a preferred viscosity range with a viscosity κ between 50 mPa/s≦κ≦500 Pa/s.

In the installed state, the valve piston seals the opening of the nozzle of the dispenser reservoir in the closed position with biasing. In order to achieve this, the holding ring has a height which is less than the height of the valve piston so that the valve piston with its truncated cone or its hemispherical or partially spherical shape, when in the unloaded state, extends beyond the ring and is accordingly pressed against the opening in the nozzle of the dispenser reservoir by the resilient holding bands with biasing to form a seal. By varying the difference in height, the contact-producing pressure which the holding bands exert on the opening of the nozzle can be increased. At the same time this means that, in order to expel the viscous medium from the dispenser reservoir, the expelling mechanism must deliver a correspondingly greater pressure.

In order to clamp the stop check valve in place between the nozzle and the dispenser delivery tube, the nozzle of the dispenser reservoir is provided, for example, with a rapid closure. The dispenser delivery tube opens out, preferably conically, towards the nozzle so that the dispenser delivery tube can be brought into engagement with the rapid closure of the nozzle with clamping in place of the stop check valve. A rapid closure of such a kind can be a Luer-lock closure, as is frequently used in dentistry, or a bayonet closure or also a conical clamping closure whose closure force is greater than the forces acting on it when the viscous medium is being expelled from the dispenser reservoir.

The dispenser is preferably provided with a fine dispenser delivery tube tip for dental root treatments and gutta-percha fillings of tooth roots, or for dental cement fillings of dental cavities. For the purpose, the dispenser delivery tube preferably has a tip having an external diameter of less than or equal to 0.5 mm. Preferably, the dispenser delivery tube is elastic and flexible. This has the advantage that root canal filling material can be introduced into the apical part of the pre-prepared root canals using this fine dispenser delivery tube tip. Further canals can also be filled with gutta-percha material using this fine dispenser delivery tube tip so that ultimately all the root canals of a tooth are filled, after which, using the same instrument, that is to say using the same impelling mechanism but with another dispenser reservoir and a new dispenser delivery tube, a dental cement is introduced into the dental cavity above the root canals.

For such dentistry applications, the dispenser reservoir has a capsule having two compartments for two components, which are mixed and/or homogenised before or during the expelling process by means of a trituration process. Such dispenser reservoirs can comprise dental cement in a dental cement capsule or root canal filling material in, preferably, a GuttaFlow capsule.

In a preferred embodiment the delivery reservoir is a rigid inflexible pressure vessel, which contains the viscous media in compressed form. Preferably, the viscous media is thixotropic. In case of the root canal filling material the viscous media is preferably a composition, which contains gutta-percha, nano-silver and an addition cross-linking sealer on basis of silicone. The gutta-percha component is preferably contained in the root canal filling material in powder form with a particle size of less than 30 μm. Preferably, sealer and gutta-percha are present in a ration of 1:1 in the root canal filling material.

In addition to those specialist applications, such a stop check valve can also be provided for dispenser reservoirs containing adhesives, cleaning agents, food and/or hygiene agents, such as toothpaste or creams, in which case the impelling mechanism comprises deformation of an appropriate tube as the dispenser reservoir. Finally, as the dispenser there can also be provided a syringe for viscous media, comprising such a stop check valve. The dispenser according to the invention can be used especially advantageously for viscous media such as silicones, dental root canal filling materials or dental cements.

The invention will now be explained in greater detail with reference to the accompanying Figures.

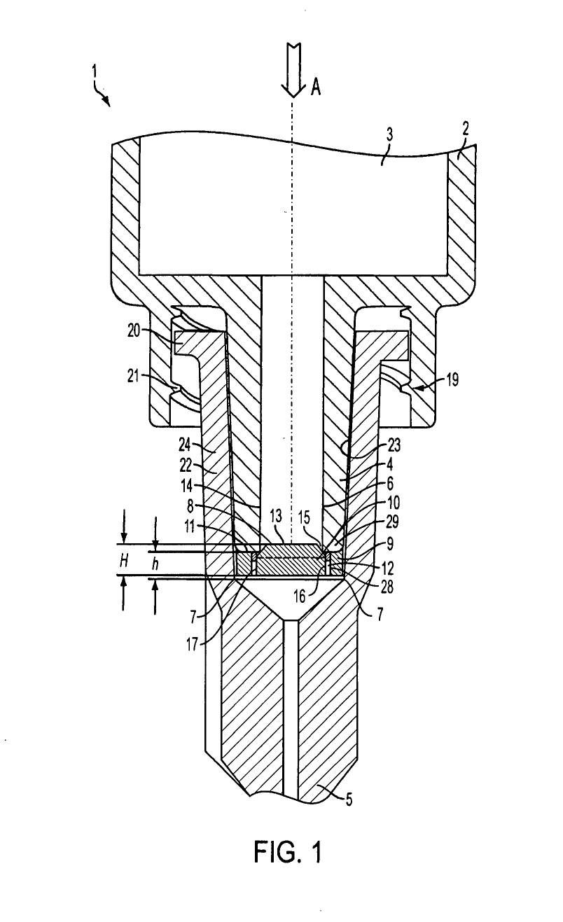

FIG. 1 is a cross-section, in diagrammatic form, through a sub-region of a dispenser in accordance with an embodiment of the invention;

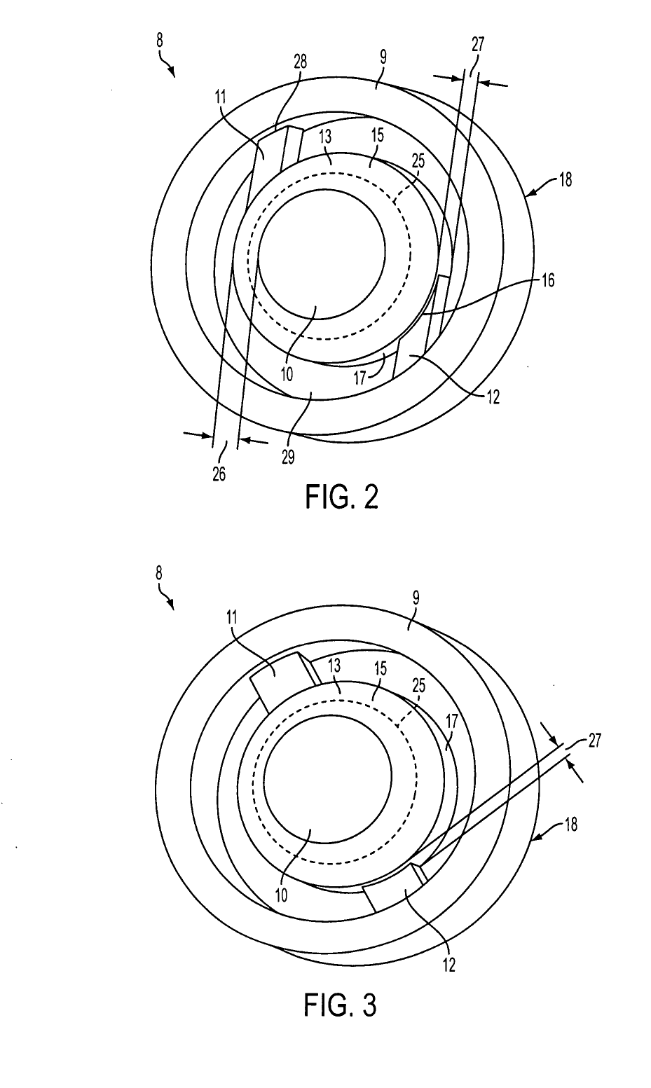

FIG. 2 is a perspective view, in diagrammatic form, of a stop check valve for the dispenser according to FIG. 1;

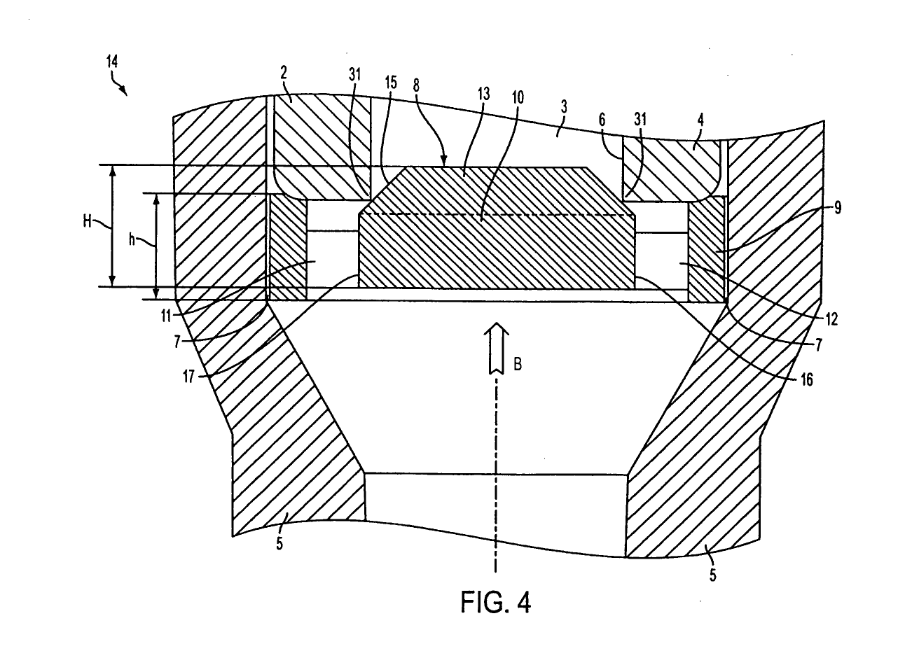

FIG. 3 is a perspective view, in diagrammatic form, of a variant of the stop check valve for the dispenser according to FIG. 1;

FIG. 4 is a cross-section, in diagrammatic form, through part of the dispenser according to FIG. 1, with the stop check valve in a closed position;

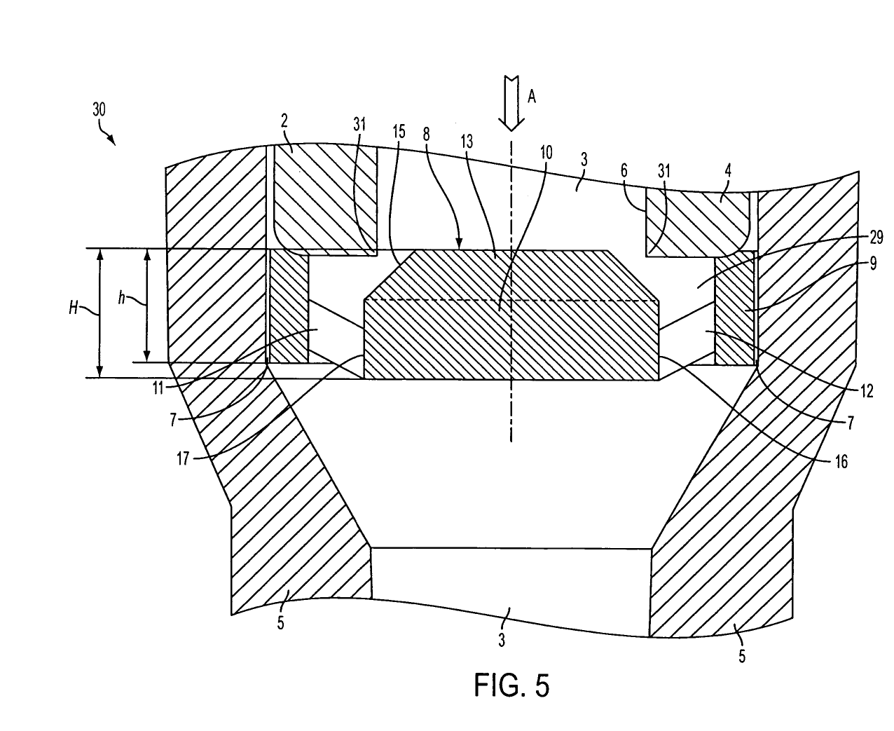

FIG. 5 is a cross-section, in diagrammatic form, through part of the dispenser according to FIG. 1, with the stop check valve in an open position.

FIG. 1 is a cross-section, in diagrammatic form, through a sub-region of a dispenser 1 in accordance with an embodiment of the invention. The dispenser 1 has a dispenser reservoir 2 for holding a viscous medium 3. The dispenser reservoir 2 has a nozzle 4, which has an opening 6, through which the viscous medium 3 can be expelled from the dispenser reservoir 2 into a dispenser delivery tube 5. In order for the viscous medium 3 to be expelled into the dispenser delivery tube 5, the dispenser reservoir 2 has a pressure piston (not shown) on which an expelling device (not shown) acts in such a way that the viscous mass 3 is pressed towards the opening 6 in the nozzle 4 in the direction of arrow A.

Between the nozzle 4 of the dispenser reservoir 2 and the dispenser delivery tube 5 there is arranged a stop check valve 8 which closes the opening 6 of the nozzle 4 with a movable valve piston 10. The valve piston 10 has a cylindrical region, having a cylindrical outer surface 17, and a truncated cone 13, having a conical outer surface 15. In the unpressurised state, the conical outer surface 15 is pressed, in a closed position 14, against the opening 6 of the nozzle 4, resilient holding bands 11 and 12 bringing about the contact-producing pressure of the truncated cone 13 of the valve piston 10 against the opening 6 of the nozzle 4. For the purpose, the resilient holding bands 11 and 12 are, in each case at one end 16, fixed to the cylindrical outer surface 17 of the valve piston 10 and, at the other, second end 28, the holding bands 11 and 12 are supported on a holding ring 9, which is clamped in place between the nozzle 4 of the dispenser reservoir 2 and a seat 7 of the dispenser delivery tube.

Clamping in place is accomplished as a result of biasing a rapid closure 19 by pushing the conically widening dispenser delivery tube 5 onto the nozzle 4 of the dispenser reservoir 2 with a turning movement. In the case of the rapid closure 19 shown in FIG. 1, a flange projection 20 of the conically widening end of the dispenser delivery tube 5 is in engagement with an internal thread 21 of the nozzle 4 of the dispenser reservoir 2 once the conically widening end 22 of the dispenser delivery tube 5, which has an internal cone 24, is pushed onto an external cone 23 of the nozzle 4 and is then rotated in the internal thread 21.

At the same time, the holding ring 9 of the stop check valve 8 is, in the process, clamped in place and fixed between the clamping seat 7 of the dispenser delivery tube 5 and the nozzle 4 of the dispenser reservoir 2.

The intermediate space 29 between the holding ring 9 and the valve piston 10 is not entirely taken up by the holding bands 11 and 12 so that a free intermediate space 29 exists, through which the viscous medium can pass from the dispenser reservoir 2 into the dispenser delivery tube 5 with the valve piston 10 in an open position when pressure is being exerted in the direction of arrow A. Once the pressure on the viscous medium in the direction of arrow A diminishes, the valve piston 10, biased by the holding bands 11 and 12, closes the opening 6 of the nozzle 4 as a result of the valve piston 10 automatically returning to the closed position 14 owing to the spring force of the holding bands 11 and 12. As a result, subsequent dripping of the viscous medium or a subsequent flow of the viscous medium from the opening 6 of the nozzle 4 of the dispenser reservoir 2 is prevented and also, at the same time, air is prevented from being able to enter the dispenser reservoir 2.

FIG. 2 is a perspective view, in diagrammatic form, of a stop check valve 8 comprising a one-piece, moulded plastics part 18 for the dispenser 1 shown in FIG. 1. The holding ring 9 surrounds a valve piston 10, which has a truncated cone region 26 and a cylindrical region 27. On the truncated cone region 26 a broken line 25 traces the position of the opening 6—shown in FIG. 1—of the nozzle 4 where the nozzle 4 shown in FIG. 1 is in contact with the valve piston 10 in a closed position. The holding bands 11 and 12, at their first end 16, are fixed in the cylindrical region 27 of the valve piston 10 and, at their second end 28, are supported on the holding ring 9. The intermediate space 29 accordingly remains free for the passage of the viscous medium 3 once the valve piston 10 leaves the closed position. In this embodiment of the invention, the resilient holding bands 11 and 12 are fixed to the valve piston 10 tangentially.

FIG. 3 is a perspective view, in diagrammatic form, of a variation of the stop check valve 8 according to FIG. 2. Components having the same functions as in FIG. 2 are identified by the same reference numerals in FIG. 3 and are not separately discussed. This variation of the stop check valve 8 has the difference that the one-piece stop check valve 8, which comprises a holding ring 9, holding bands 11 and 12 and a valve piston 10, has an arrangement of holding bands 11 and 12 which differs from FIG. 2. In this variant, the holding bands 11 and 12 extend radially outwards from the cylindrical region 27 of the valve piston 10 towards the holding ring 9. As a result, the holding bands 11 and 12 in FIG. 3 are shorter than in FIG. 2, so that if the stop check valves 8 have the same materials properties the stop check valve 8 of FIG. 3 is more rigid than that of FIG. 2.

FIG. 4 is a cross-section, in diagrammatic form, through part of the dispenser 2 according to FIG. 1 in a closed position 14 of the stop check valve 8. Components having the same functions as in the preceding Figures are identified by the same reference numerals and are not separately discussed. The height h of the holding ring 9 clamped in place between the clamping seat 7 of the dispenser delivery tube 5 and the nozzle 4 of the dispenser reservoir 2 is less than the height H of the valve piston 10. As a result, the valve piston 10 can extend into the opening 6 of the nozzle 4 of the dispenser reservoir 2. In addition, the resilient holding bands 11 and 12 can exert a spring force on the valve piston 10 in the direction of arrow B so that the valve piston 10 is pressed against the rim 31 of the opening 6 of the nozzle 4 in the closed position 14.

FIG. 5 is a cross-section, in diagrammatic form, through part of the dispenser 1 according to FIG. 1 in an open position 30 of the stop check valve 8. If a higher pressure is exerted on the viscous medium 3 in direction A than is made available by the restoring force of the resilient holding bands 11 and 12, the valve piston 10 is pressed in the direction of arrow A into the open position 30 and the viscous medium 3 can enter the dispenser delivery tube 5 by way of the intermediate space 29. However, as soon as the pressure in direction A diminishes, the resilient holding bands 11 and 12 return and the valve piston 10 closes the opening 6 of the nozzle 4 of the dispenser reservoir 2 so that a subsequent flow of the viscous medium is prevented. At the same time, the entry of air into the dispenser reservoir and, therefore, into the viscous medium 3 is also prevented once the valve piston 10 has been returned from the open position 30 shown here to the closed position 14 shown in FIG. 4. A stop check valve 8 of such a kind can in principle be used in any dispenser without major restructuring and consequently allows a contribution to be made towards economic handling of expensive viscous media.

### LIST OF REFERENCE SYMBOLS

1 dispenser
2 dispenser reservoir
3 viscous medium
4 nozzle
5 dispenser delivery tube
6 opening in nozzle
7 seat
8 stop check valve
9 holding ring
10 valve piston
11 holding band
12 holding band
13 truncated cone
14 closed position
15 conical outer surface
16 end of holding band
17 cylindrical outer surface
18 one-piece plastics part
19 rapid closure
20 flange projection
21 internal thread
22 conical end
23 external cone
24 internal cone
25 broken line
26 truncated cone region
27 cylindrical region
28 second end
29 intermediate space
30 open position
31 rim
A arrow direction
B arrow direction
h height of holding ring
H height of valve pist

1. Dispenser having a dispenser reservoir (2) for viscous media (3) which has a nozzle (4), having an expelling mechanism and having a dispenser delivery tube (5), wherein the expelling mechanism exerts a pressure on the viscous medium (3) in the dispenser reservoir (2) and expels the viscous medium (3) by way of an opening (6) in the nozzle (4) of the dispenser reservoir (2) and through the dispenser delivery tube (5), wherein the dispenser delivery tube (5) is removable from the dispenser reservoir (2), and wherein the dispenser delivery tube (5) has a seat (7) for a stop check valve (8) which is arranged between the nozzle (4), having the opening (6), and the dispenser delivery tube (5).

2. Dispenser according to claim 1,
characterised in that
the stop check valve (8) has a holding ring (9) and a movable valve piston (10), there being arranged between the holding ring (9) and the valve piston (10) resilient holding bands (11, 12), which hold the valve piston (10) in a closed position (14), in which the opening (6) of the nozzle (4) of the dispenser reservoir (2) is closed.

3. Dispenser according to claim 2,
characterised in that
the valve piston (10) has towards the nozzle (4) a truncated cone (13), the conical outer surface (15) of which seals the opening (6) in the unpressurised state.

4. Dispenser according to claim 2,
characterised in that
the resilient holding bands (11, 12) are, at a first end (16), arranged on a cylindrical outer surface (17) of the valve piston (10) and extend radially outwards from the cylindrical outer surface (17) to the holding ring (9).

5. Dispenser according to claim 2,
characterised in that
the resilient holding bands (11, 12) are, at a first end (16), arranged on a cylindrical outer surface (17) of the valve piston (10) and extend tangentially, or at an obtuse angle to the radial, outwards from the cylindrical outer surface (17) to the holding ring (9).

6. Dispenser according to claim 2,
characterised in that
the holding ring (9) is arranged between the nozzle (4) and the dispenser delivery tube (5).

7. Dispenser according to claim 2,
characterised in that
on application of the dispenser delivery tube (5) to the nozzle (4) of the dispenser reservoir (2) the holding ring (9) occupies a clamping seat (7).

8. Dispenser according to claim 2,
characterised in that
a one-piece plastics part (18) comprises the valve piston (10), the holding bands (11, 12) and the holding ring (9).

9. Dispenser according to claim 2,
characterised in that
in the installed state the valve piston (10) seals off the opening (6) of the nozzle (4) of the dispenser reservoir (2) in the closed position (14) with biasing.

10. Dispenser according to claim 2,
characterised in that
the holding ring (9) has a height (h) which is less than the height (H) of the valve piston, and in the unloaded state the valve piston (10), by means of a truncated cone (13), extends beyond the holding ring.

11. Dispenser according to claim 1,
characterised in that
a rapid closure (19) is arranged on the nozzle (4), and the dispenser delivery tube (5) opens out conically towards the nozzle (4), and the dispenser delivery tube (5) is arranged to be brought into engagement with the rapid closure (14) of the nozzle (4) with clamping in place of the stop check valve (8).

12. Dispenser according to claim 1,
characterised in that
the dispenser delivery tube (5) is suitable for dental root treatments and gutta-percha fillings of tooth roots or for dental cement fillings of dental cavities and at its tip has an external diameter of less than or equal to 0.5 mm.

13. Dispenser according to claim 1,
characterised in that
the dispenser reservoir (2) has a capsule having two compartments for two components, which are mixed and/or homogenised before or during the expelling process by means of a trituration process.

14. Dispenser according to claim 1,
characterised in that
the dispenser reservoir (2) has a dental cement capsule.

15. Dispenser according to claim 1,
characterised in that
the dispenser reservoir (2) has a capsule for root canal filling material, preferably a GuttaFlow capsule.

16. Dispenser according to claim 1,
characterised in that
the dispenser reservoir (2) has a rapid closure, preferably a Luer-lock closure, as nozzle.

17. Dispenser according to claim 1,
characterised in that
the dispenser reservoir (2) comprises a pressure cylinder having a pressure piston, a pressure gun being in operative connection with the pressure piston by way of a rod assembly having a pressure plate.

18. Dispenser according to claim 1,
characterised in that
the dispenser reservoir (2) is a tube of adhesive, a tube of cleaning agent, a tube of food, or a hygienic agent tube for toothpaste or creams, and the impelling mechanism brings about deformation of the tube.

19. Dispenser according to claim 1,
characterised in that
the dispenser (1) is a syringe for viscous media (3).

20. Use of the dispenser for handling viscous media (3) having a viscosity κ between 50 mPa/s≦κ≦500 Pa/s.

21. Use of the dispenser, according to claim 20,
characterised in that
silicones, dental root canal filling materials or dental cements are used as viscous media.
